(19) United States
(12) Patent Application Publication
(10) Pub. No.: US 2022/0327400 A1
(43) Pub. Date: Oct. 13, 2022

(54) SYSTEM AND METHOD OF OUTLIER DETECTION AND NON-TRANSITORY COMPUTER READABLE MEDIUM

(71) Applicant: National Yang Ming Chiao Tung University, Hsinchu City (TW)

(72) Inventors: Jeng-Fang CHANG, Taichung City (TW); Jwo-Yuh WU, Hsinchu City (TW); Liang-Chi HUANG, Taichung City (TW); Rung-Hung GAU, New Taipei City (TW)

(21) Appl. No.: 17/225,095

(22) Filed: Apr. 7, 2021

(51) Int. Cl. G06N 5/04; G06N 20/00

(52) U.S. Cl. CPC G06N 5/04; G06N 20/00

(57) ABSTRACT

A method of outlier detection includes steps as follows. Distances from an input data point to a plurality of subspaces respectively are calculated. A minimum distance is selected from the distances to leave one or more remaining distances. The one or more remaining distances are utilized to normalize the minimum distance to obtain the normalized distance value. Whether the normalized distance value is greater than a threshold value is detected, so as to output a detection result.

### BACKGROUND

### Field of Invention

The present invention relates to systems and methods, and more particularly, systems and methods of outlier detection.

### Description of Related Art

In data analysis, anomaly detection (also outlier detection) is the identification of rare items, events or observations which raise suspicions by differing significantly from the majority of the data.

For example, the sparsity concentration index (SCI) method exploits the idea of sparse representation for outlier detection, and the work the Generalized Pareto distribution (GPD) is further used to fit the tail distribution of the computed residuals. However, these sparse representation based methods are not suited for current real-time applications, due to their high complexity.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one or more various aspects, the present disclosure is directed to a systems and methods of outlier detection, to solve or circumvent aforesaid problems and disadvantages in the related art.

An embodiment of the present disclosure is related to a system of outlier detection, and the system includes a storage device and a processor. The storage device is configured to store at least one instruction and a data model of a plurality of subspaces. The processor is electrically connected to the storage device and is configured to access and execute the at least one instruction for: calculating distances from an input data point to the subspaces respectively; selecting a minimum distance from the distances to leave one or more remaining distances; utilizing the one or more remaining distances to normalize the minimum distance to obtain the normalized distance value; detecting whether the normalized distance value is greater than a threshold value, so as to output a detection result.

Another embodiment of the present disclosure is related to a method of outlier detection, and the method includes steps as follows. Distances from an input data point to a plurality of subspaces respectively are calculated. A minimum distance is selected from the distances to leave one or more remaining distances. The one or more remaining distances are utilized to normalize the minimum distance to obtain the normalized distance value. Whether the normalized distance value is greater than a threshold value is detected, so as to output a detection result.

Yet another embodiment of the present disclosure is related to a non-transitory computer readable medium to store a plurality of instructions for commanding a computer to execute a method of outlier detection, and the method includes steps as follows. Distances from an input data point to a plurality of subspaces respectively are calculated. A minimum distance is selected from the distances to leave one or more remaining distances. The one or more remaining distances are utilized to normalize the minimum distance to obtain the normalized distance value. Whether the normalized distance value is greater than a threshold value is detected, so as to output a detection result.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a system of outlier detection according to some embodiments of the present disclosure;

FIG. 2 is a schematic diagram of operations of the system according to some embodiments of the present disclosure; and

FIG. 3 is a flow chart of a method of the outlier detection according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

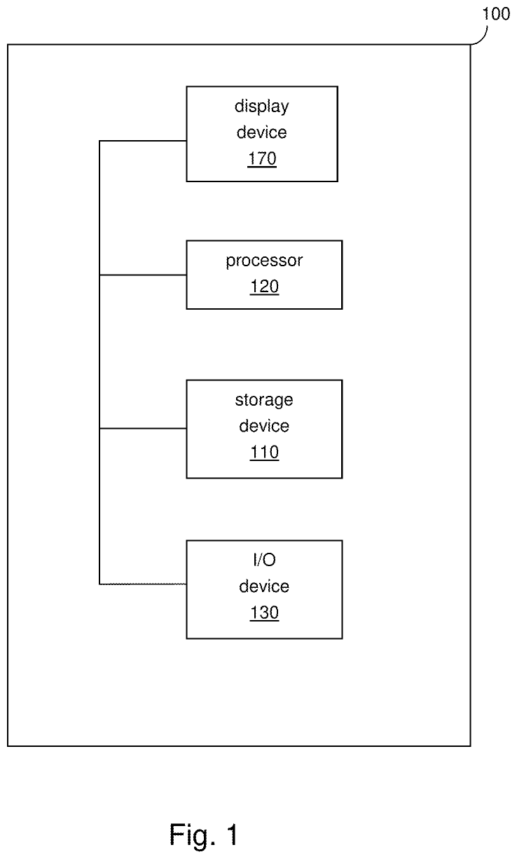

FIG. 1 is a block diagram of a system 100 of outlier detection according to some embodiments of the present disclosure. The system 100 may be easily integrated into any computer and may be applicable or readily adaptable to all technologies. Compared with the conventional manner, the system 100 has low algorithmic complexity and outstanding performance.

In the following description as to the system 100 of outlier detection, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

As shown in FIG. 1, the system 100 includes a storage device 110, a processor 120, an input/output (I/O) device 130 and a display device 170. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

For example, the system 100 may be a computer or the like, in which the storage device 110 may be storage hardware, such as a hard disk drive (HDD) and/or a solid-state drive (SSD), the processor 120 may be a central processing unit (CPU), a microcontroller or the like, the I/O device 130 may include an input device and/or an output device, and the display device 170 may be a LCD or the like. As used herein, the term “and/or” includes any and all combinations of one or more of the associated listed items.

In structure, the processor 120 is electrically connected to the storage device 110, the I/O device 130 is electrically connected to the processor 120, and the processor 120 is electrically connected to the display device 170. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. For example, the display device 170 is a built-in display device that is directly connected to the processor 120, or the display device 170 is an external display device that is indirectly coupled with the processor 120.

In use, the system 100 can establish a data model of a plurality of subspaces firstly. For example, the I/O device 130 is configured to receive a plurality of classes of labeled training data, and the storage device 110 is configured to store the plurality of the classes of the labeled training data. In practice, the storage device 110 is also configured to store at least one instruction, and the processor 120 is configured to access and execute the instruction for collecting data points from the plurality of the classes of the labeled training data respectively to generate respective data matrixes. Then, the processor 120 is configured to access and execute the instruction for utilizing columns of each of the respective data matrixes to span each of the subspaces correspondingly. Then, the processor 120 is configured to access and execute the instruction for normalizing all of data points of the subspaces to be unit-norms. Then, the processor 120 is configured to access and execute the instruction for storing the data model of the subspaces in the storage device 110. As used in the description herein and throughout the claims that follow, the meaning of “in” includes “in” and “on” unless the context clearly dictates otherwise.

After the data model of the subspaces has been established, for example, the I/O device 130 is configured to receive an input data point, and the storage device 110 is configured to store the input data point. In use, the processor 120 is configured to access and execute the instruction for calculating distances (e.g., orthogonal projection distances) from the input data point to the subspaces respectively. Then, the processor 120 is configured to access and execute the instruction for selecting a minimum distance from the distances to leave one or more remaining distances. Then, the processor 120 is configured to access and execute the instruction for utilizing the one or more remaining distances to normalize the minimum distance to obtain the normalized distance value. Finally, the processor 120 is configured to access and execute the instruction for detecting whether the normalized distance value is greater than a threshold value, so as to output a detection result. For example, the processor 120 is configured to output the detection result to the display device 170, and the display device 170 is configured to display the detection result; additionally or alternatively, the processor 120 is configured to output the detection result to the I/O device 130, and the I/O device 130 is configured to transmit the detection result to an external device, such as a server, or the like.

In some embodiments, the detection result indicates that the input data point is an outlier in response to that the normalized distance value is greater than the threshold value. On the contrary, in some embodiments, the detection result indicates that the input data point is an inlier in response to that the normalized distance value is less than or equal to the threshold value.

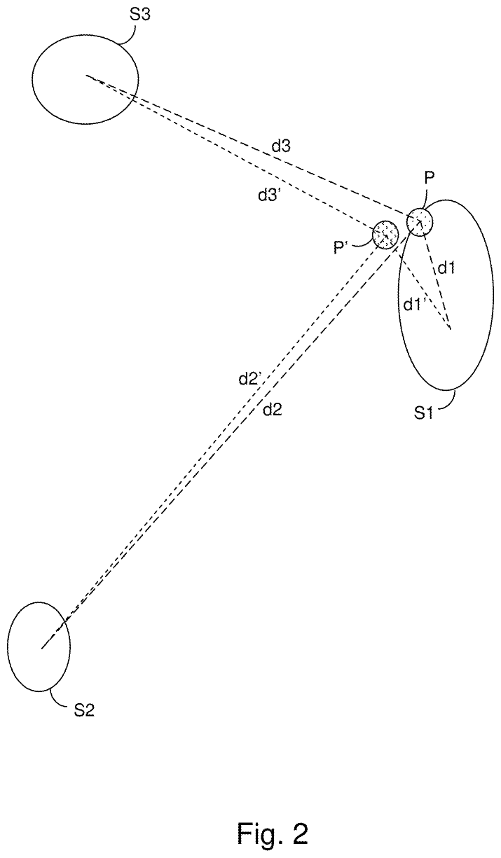

For a more complete understanding of operations of the system 100, referring FIGS. 1-2, FIG. 2 is a schematic diagram of operations of the system 100 according to some embodiments of the present disclosure.

In some embodiments, the storage device 110 is configured to store at least one instruction and the data model of a plurality of subspaces S1, S2 and S3. When receiving a first input data point P, the processor 120 is configured to access and execute the instruction for calculating distances d1, d2 and d3 from the first input data point P to the subspaces S1, S2 and S3 respectively. Then, the processor 120 is configured to access and execute the instruction for selecting a minimum distance d1 from the distances d1, d2 and d3 to leave remaining distances d2 and d3. Then, the processor 120 is configured to access and execute the instruction for utilizing the remaining distances d2 and d3 to normalize the minimum distance d1 to obtain the first normalized distance value. Finally, the processor 120 is configured to access and execute the instruction for detecting whether the first normalized distance value is greater than the threshold value, so as to output a first detection result. In some embodiments, the first detection result indicates that the first input data point P is the inlier in response to that the first normalized distance value is less than the threshold value.

Similarly, when receiving a second input data, the processor 120 is configured to access and execute the instruction for calculating distances d1′, d2′ and d3′ from the second input data point P′ to the subspaces S1, S2 and S3 respectively. Then, the processor 120 is configured to access and execute the instruction for selecting a minimum distance d1′ from the distances d1′, d2′ and d3′ to leave remaining distances d2′ and d3′. Then, the processor 120 is configured to access and execute the instruction for utilizing the remaining distances d2′ and d3′ to normalize the minimum distance d1′ to obtain the second normalized distance value. Finally, the processor 120 is configured to access and execute the instruction for detecting whether the second normalized distance value is greater than the threshold value, so as to output a second detection result. In some embodiments, the second detection result indicates that the second input data point P is the outlier in response to that the second normalized distance value is greater than the threshold value.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

As shown in FIG. 2, the distance d1′ from the second input data point P′ to the subspace S1 is approximately the same as the distance d1 from to the subspace S1. In a control experiment, the remaining distances d2′ and d3′ is not utilized to normalize the minimum distance d1′, and the remaining distances d2 and d3 is not utilized to normalize the minimum distance d1; however, it is very difficult to decide a precise threshold distance for discriminating the outlier from the inlier since the distance d1′ is approximately the same as the distance d1, and thus the second input data point P′ may be falsely determined as the inlier. As used herein, “around”, “about” or “approximately” shall generally mean within 20 percent, preferably within 10 percent, and more preferably within 5 percent of a given value or range. Numerical quantities given herein are approximate; meaning that the term “around”, “about” or “approximately” can be inferred if not expressly stated.

As to above normalization of the present disclosure, specifically, in some embodiments, the processor 120 accesses and executes the instruction for calculating an average of the remaining distances d2 and d3. Then, the processor 120 is configured to access and execute the instruction for dividing the minimum distance d1 by the average of the remaining distances d2 and d3 to equal the first normalized distance ratio serving as above first normalized distance value.

Similarly, in some embodiments, the processor 120 accesses and executes the instruction for calculating an average of the remaining distances d2′ and d3′. Then, the processor 120 is configured to access and execute the instruction for dividing the minimum distance d1′ by the average of the remaining distances d2′ and d3′ to equal the second normalized distance ratio serving as above second normalized distance value.

As shown in FIG. 2, the distances d2′ and d3′ are apparently shorter than the distances d2 and d3, and therefore the second normalized distance ratio is distinctly greater than the first normalized distance ratio. In this way, it is easy to determine the second input data point P′ as the outlier correctly, without more highly algorithmic complexity.

In some embodiments, above threshold value can be a threshold ratio that is less than one. In practice, those with ordinary skill in the art may flexibly adjust the threshold value (e.g., the threshold ratio) depending on the empirical data, machine learning, or the like.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

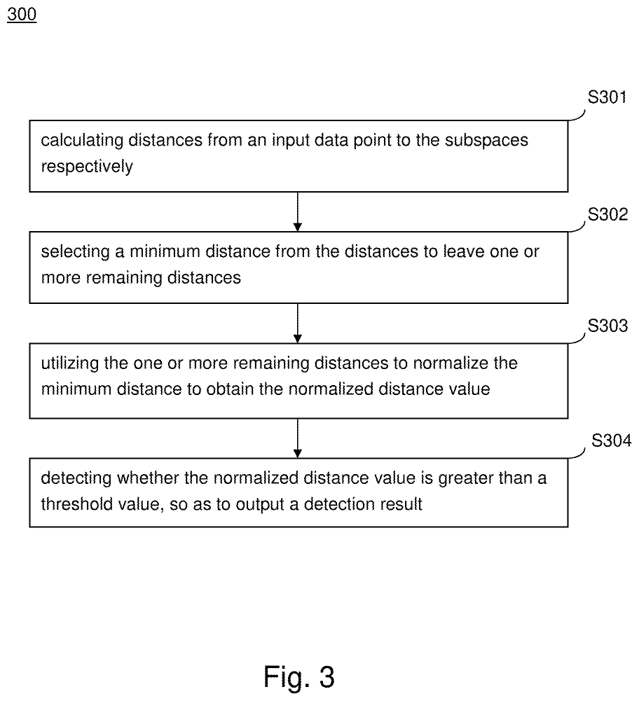

For a more complete understanding of a method performed by the system 100, referring FIGS. 1-3, FIG. 3 is a flow chart of the method 300 of outlier detection according to an embodiment of the present disclosure. As shown in FIG. 3, the method 300 includes operations S301, S302, S303 and S304. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The method 300 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In operation S301, distances from an input data point to a plurality of subspaces respectively are calculated. Then, in operation S302, a minimum distance is selected from the distances to leave one or more remaining distances. Then, in operation S303, the one or more remaining distances are utilized to normalize the minimum distance to obtain the normalized distance value. Then, in operation S304, whether the normalized distance value is greater than a threshold value is detected, so as to output a detection result.

In some embodiments, the detection result indicates that the input data point is an outlier in response to that the normalized distance value is greater than the threshold value. Alternatively, in some embodiments, the detection result indicates that the input data point is an inlier in response to that the normalized distance value is less than or equal to the threshold value.

As to above normalization of operation S303, specifically, in some embodiments, an average of the one or more remaining distances are calculated, and then the minimum distance divided by the average of the one or more remaining distances equals a normalized distance ratio serving as the normalized distance value. The threshold value is a threshold ratio.

In some embodiments, before operation S301, in the method 300, data points are collected from a plurality of classes of labeled training data respectively to generate respective data matrixes, columns of each of the respective data matrixes are utilized to span each of the subspaces correspondingly, and then all of data points of the subspaces are normalized to be unit-norms respectively. In this way, the data model of the plurality of subspaces is established.

In view of the above, technical advantages are generally achieved, by embodiments of the present disclosure. In the present disclosure, all of the distances from the input data point to the subspaces respectively are considered, and the remaining distances are utilized to normalize the minimum distance. Compared with conventional manners (e.g., SCI, GPD and so on), the system 100 and method 300 have low algorithmic complexity, so that the present disclosure can be suited for real-time applications. In practice, the performance of the system 100 and method 300 is better than SCI, GPD and above control experiment. Especially in the case of high compression rate, the present disclosure is less affected by the data distortion due to dimensional reduction.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system of outlier detection, and the system comprising:
a storage device configured to store at least one instruction and a data model of a plurality of subspaces; and
a processor electrically connected to the storage device and configured to access and execute the at least one instruction for:
calculating distances from an input data point to the subspaces respectively;
selecting a minimum distance from the distances to leave one or more remaining distances;
utilizing the one or more remaining distances to normalize the minimum distance to obtain the normalized distance value; and
detecting whether the normalized distance value is greater than a threshold value, so as to output a detection result.

2. The system of claim 1, wherein the detection result indicates that the input data point is an outlier in response to that the normalized distance value is greater than the threshold value.

3. The system of claim 1, wherein the detection result indicates that the input data point is an inlier in response to that the normalized distance value is less than or equal to the threshold value.

4. The system of claim 1, wherein the processor accesses and executes the at least one instruction for:
calculating an average of the one or more remaining distances; and
dividing the minimum distance by the average of the one or more remaining distances to equal a normalized distance ratio serving as the normalized distance value, wherein the threshold value is a threshold ratio.

5. The system of claim 1, wherein the processor accesses and executes the at least one instruction for:
collecting data points from a plurality of classes of labeled training data respectively to generate respective data matrixes;
utilizing columns of each of the respective data matrixes to span each of the subspaces correspondingly;
normalizing all of data points of the subspaces to be unit-norms; and
storing the data model of the subspaces in the storage device.

6. A method of outlier detection, and the method comprising steps of:
calculating distances from an input data point to a plurality of subspaces respectively;
selecting a minimum distance from the distances to leave one or more remaining distances;
utilizing the one or more remaining distances to normalize the minimum distance to obtain the normalized distance value; and
detecting whether the normalized distance value is greater than a threshold value, so as to output a detection result.

7. The method of claim 6, wherein the detection result indicates that the input data point is an outlier in response to that the normalized distance value is greater than the threshold value.

8. The method of claim 6, wherein the detection result indicates that the input data point is an inlier in response to that the normalized distance value is less than or equal to the threshold value.

9. The method of claim 6, wherein the step of utilizing the one or more remaining distances to normalize the minimum distance to obtain the normalized distance value comprises:
calculating an average of the one or more remaining distances; and
dividing the minimum distance by the average of the one or more remaining distances to equal a normalized distance ratio serving as the normalized distance value, wherein the threshold value is a threshold ratio.

10. The method of claim 6, further comprising:
collecting data points from a plurality of classes of labeled training data respectively to generate respective data matrixes;
utilizing columns of each of the respective data matrixes to span each of the subspaces correspondingly; and
normalizing all of data points of the subspaces to be unit-norms respectively.

11. A non-transitory computer readable medium to store a plurality of instructions for commanding a computer to execute a method of outlier detection, and the method comprising steps of:
calculating distances from an input data point to a plurality of subspaces respectively;
selecting a minimum distance from the distances to leave one or more remaining distances;
utilizing the one or more remaining distances to normalize the minimum distance to obtain the normalized distance value; and
detecting whether the normalized distance value is greater than a threshold value, so as to output a detection result.

12. The non-transitory computer readable medium of claim 11, wherein the detection result indicates that the input data point is an outlier in response to that the normalized distance value is greater than the threshold value.

13. The non-transitory computer readable medium of claim 11, wherein the detection result indicates that the input data point is an outlier in response to that the normalized distance value is greater than the threshold value.

14. The non-transitory computer readable medium of claim 11, wherein the step of utilizing the one or more remaining distances to normalize the minimum distance to obtain the normalized distance value comprises:
calculating an average of the one or more remaining distances; and
dividing the minimum distance by the average of the one or more remaining distances to equal a normalized distance ratio serving as the normalized distance value, wherein the threshold value is a threshold ratio.

15. The non-transitory computer readable medium of claim 11, wherein the method further comprises:
collecting data points from a plurality of classes of labeled training data respectively to generate respective data matrixes;
utilizing columns of each of the respective data matrixes to span each of the subspaces correspondingly; and
normalizing all of data points of the subspaces to be unit-norms respectively.
